(19) United States
(12) Patent Application Publication
(10) Pub. No.: US 2007/0107595 A1
(43) Pub. Date: May 17, 2007

(54) Method and apparatus for collecting chemical compounds from semiconductor processing

(76) Inventor: Myung-Soo Na, Seongnam-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/273,633

(22) Filed: Nov. 14, 2005

(51) Int. Cl. B01D 53/00

(52) U.S. Cl. 95/288

(57) ABSTRACT

Disclosed is an apparatus for quickly catching reaction by-products introduced from a process chamber in semiconductor equipment. The apparatus solidifies the reaction by-products into powder within a short period of time by cooling the reaction by-products and ionizes the reaction by-products by applying energy to the reaction by-products such that the reaction by-products are deposited in the form of lamination layers, thereby improving the efficiency of catching the reaction by-products. The apparatus includes a housing having first and second connection ports, a heating unit installed in the housing so as to heat the reaction by-products introduced into the housing through the first connection port such that the reaction by-products are ionized, and a cooling unit for rapidly cooling the reaction by-products heated by means of the heating unit by circulating a low-temperature coolant, which is injected into the cooling unit, through the housing.

### BACKGROUND OF THE INVENTION

1. Field of the Invention

The present invention relates to a semiconductor device. More particularly, the present invention relates to an apparatus adaptable for quickly catching by-products, such as non-reacted gas and toxic gas, which are generated from a process chamber when semiconductor devices are manufactured in semiconductor equipment.

2. Description of the Related Technology

In general, a semiconductor manufacturing process is mainly divided into a fabrication process and an assembly process. During the fabrication process, thin films are deposited on a wafer in various process chambers and the deposited thin films are repeatedly etched such that predetermined patterns are formed on the wafer, thereby fabricating a semiconductor chip. In addition, during the assembly process, the semiconductor chip fabricated through the fabrication process is sawn into individual chips and the individual chips are assembled with a lead frame, thereby obtaining a semiconductor device.

The processes for depositing the thin films on the wafer and etching the thin films deposited on the wafer are performed under the high temperature atmosphere while introducing toxic gas (e.g. silane, arsine or boron chloride) and process gas (e.g. hydrogen) into the process chamber. In addition, while the above processes are being performed, various flammable gases, erosive impurities and toxic gases containing hazard components are generated in the process chamber.

For this reason, a scrubber is installed in semiconductor equipment at a rear end portion of a vacuum pump, which provides a vacuum into the process chamber, in order to purify exhaust gas discharged from the process chamber.

However, the exhaust gas discharged from the process chamber is solidified and changed into powder when it makes contact with external air or if an ambient temperature is relatively low. Such powder may stick to an exhaust line, thereby rising pressure of the exhaust gas. If the powder is introduced into the vacuum pump, the vacuum pump may malfunction. In addition, the powder causes the exhaust gas to flow backward, so that a wafer provided in the process chamber may be contaminated due to the powder.

In order to solve the above problems, as shown in FIG. 1, a powder trap device is installed between a process chamber 10 and a vacuum pump 30 in order to trap the exhaust gas discharged from the process chamber 10 by solidifying the exhaust gas in the form of powder. That is, as shown in FIG. 1, the process chamber 10 and the vacuum pump 30 are connected to a pumping line 60. In addition, a trap pipe 70 is branched from the pumping line 60 so as to trap reaction by-products, which are generated from the process chamber 10 and solidified in the form of powder.

When the conventional powder trap device is employed, non-reacted gas, which is generated in the process chamber 10 when the thin film is deposited or etched in the process chamber 10, is introduced into the pumping line 60 having a temperature relatively lower than that of the process chamber 10, so that the non-reacted gas is solidified in the form of powder 9 and stacked in the trap pipe 70 branched from the pumping line 60. At this time, since the trap pipe 70 is branched from the pumping line 60, the powder cannot be introduced into the vacuum pump 30.

However, the conventional powder trap device has following disadvantages.

First, it takes a relatively long time to change the reaction by-products into powder and then stack the powder in the trap pipe, so the process time may be lengthened. That is, the reaction by-products generated in the process chamber during the thin film deposition process or etching process must be rapidly changed into the powder and stacked in the trap pipe for the next thin film deposition process or etching process, which is performed in the process chamber under the condition that the process chamber has no reaction by-products. However, since it takes a relatively long time to change the reaction by-products into powder, the process chamber must wait for the next process until the reaction by-products have been completely removed from the process chamber. For this reason, workability of semiconductor equipment may be lowered and the turn around time (TAT) may increase.

Second, the trap pipe used for stacking the powder has a small volume, so it is necessary to frequently remove the powder stacked in the trap pipe.

### SUMMARY OF CERTAIN INVENTIVE ASPECTS

One aspect of the invention provides a method of collecting at least one chemical compound from semiconductor processing. The method comprises flowing gas comprising at least one chemical compound in a flow direction; heating at least part of the gas while the gas flows generally in the flow direction; cooling at least part of the heated gas while the gas flows generally in the flow direction; and depositing at least part of the chemical compounds on at least one deposition surface provided along the flow direction.

In the method described above, heating may comprise contacting the at least part of the gas with a heating surface. The heating surface may be heated to a temperature from about 150° C. to about 550° C. In addition, at least some gaseous particles may momentarily move in a direction substantially opposite the flow direction after contacting the heating surface. The at least one chemical compound may ionize upon heating.

In the method, cooling may comprise contacting the at least part of the heated gas with a cooling surface. The cooling surface may be cooled to a temperature from about −40° C. to about 25° C. Cooling may comprise contacting the at least part of the heated gas with the deposition surface.

Heating, cooling and depositing may be conducted in a single chamber. The chamber may comprise an interior surface, which is cooled, and cooling may comprise contacting the at least part of the heated gas with the interior surface. Alternatively, heating, cooling and deposition may be conducted in two or more consecutively arranged chambers. In the method, the gas may comprise at least one selected from the group consisting of Cl₂, BCl₃, WF₆, Ar, N₂, TiCl₄, TOES, PH₃, TMB, TMP, O₂, O₃, B₂H₆, MPA, TMA, Al, Al₂O₃, SiH₄, NH₃, PH TEOS, N₂O, H₂O, CO₂ and a compound obtained from a reaction between at least two of the foregoing compounds. The at least one deposition surface may be generally perpendicular to the flow direction.

Another aspect of the invention provides another method of collecting at least one chemical compound from semiconductor processing. The method comprises: flowing gas comprising at least one chemical compound in a flow direction; ionizing the at least one chemical compound while the gas flows generally in the flow direction; cooling at least part of the gas while the gas flows generally in the flow direction; and depositing at least part of the chemical compounds on at least one deposition surface provided along the flow direction. In the method, ionizing may comprise heating the at least one chemical compound. Ionizing may comprise applying radio frequency radiation to the gas flowing in the flow direction.

Yet another aspect of the invention provides an apparatus for collecting at least one chemical compound from semiconductor processing. The apparatus comprises: an inlet configured to receive a gaseous flow comprising at least one chemical compound; a heater configured to heat at least part of the gaseous flow; a cooler configured to cool the at least part of the heated gaseous flow; and at least one deposition plate configured to deposit at least one chemical compound thereon.

In the apparatus, the heater may comprise a heating surface substantially perpendicular to the direction of the gaseous flow. The heater may comprise at least one guide plate configured to direct the gaseous flow to the cooler. The heating surface may be configured to heat to a temperature from about 150° C. to about 550° C. The heating surface may be configured to heat to a temperature sufficient to ionize the at least one chemical compound.

In the apparatus, the cooler may comprise at least one cooling surface which is cooled by a coolant. The at least one deposition plate may comprise a cooling surface. The deposition plate may be configured to cool to a temperature from about −40° C. to about 25° C. The at least one deposition plate surface may comprise a surface substantially perpendicular to the gaseous flow.

Yet another aspect of the invention provides a semiconductor processing equipment. The semiconductor processing equipment comprises: a semiconductor processing chamber configured to process an intermediate semiconductor device with at least one chemical compound therein; a chemical compound collector configured to collect the at least one chemical compound discharged from the semiconductor processing chamber. The chemical compound collector comprises: an inlet configured to receive a gaseous flow from the semiconductor processing chamber, the gaseous flow comprising the at least one chemical compound; means for heating at least part of the gaseous flow; means for cooling the at least part of the heated gaseous flow; and means for depositing at least one chemical compound thereon.

Yet another aspect of the invention provides an apparatus for catching by-products generated in a process chamber during a thin film deposition or etching process in semiconductor equipment, the apparatus comprising: a housing including a first connection port connected to the process chamber and a second connection port connected to a vacuum pump providing a vacuum into the process chamber; a heating unit installed in the housing so as to heat reaction by-products introduced into the housing through the first connection port such that the reaction by-products are ionized; and a cooling unit for rapidly cooling the reaction by-products heated by means of the heating unit by circulating a low-temperature coolant, which is injected into the cooling unit, through the housing.

According to the preferred embodiment of the present invention, housing includes a body having a hollow cylindrical structure, in which upper and lower portions of the body are opened; an upper plate coupled with an upper portion of the body and provided with the first connection port; and a lower plate coupled with a lower portion of the body and provided with the second connection port;

The heating unit includes a heating plate installed adjacent to the first connection port of the housing so as to heat the reaction by-products by making contact with the reaction by-products introduced into the housing and a heater making contact with the heating plate so as to transfer heat required for ionizing the reaction by-products to the heating plate.

In addition, a plurality of partition walls are radially installed on an upper surface of the heating plate while defining a track therebetween in such a manner that the reaction by-products introduced into the heating plate are dispersed toward an inner wall of the housing along the track.

At this time, the partition walls have predetermined curvatures so that the reaction by-products spirally flow from a center portion to an outer peripheral portion of the heating plate.

The apparatus further comprises a cylindrical guide installed at an upper portion of the partition walls, wherein an upper portion of the cylindrical guide is communicated with the first connection port, and a lower portion of the cylindrical guide is formed with a perforation hole for guiding the reaction by-products into a center portion of an upper surface of the heating plate.

Alternatively, the partition walls have linear plate shapes so that the reaction by-products linearly flow from a center portion to an outer peripheral portion of the heating plate.

In addition, auxiliary partition walls having lengths shorter than those of the partition walls and extending from the outer peripheral portion of the heating plate toward the center portion of the heating plate are provided between the partition walls.

The apparatus further comprises a cylindrical guide installed at an upper portion of the partition walls, wherein an upper portion of the cylindrical guide is communicated with the first connection port, and a lower portion of the cylindrical guide is formed with a perforation hole for guiding the reaction by-products into a center portion of an upper surface of the heating plate.

In addition, the apparatus further comprises a plurality of trap plates installed in the housing for trapping the reaction by-products heated by means of the heating unit such that the reaction by-products are deposited on the trap plates.

The cooling unit includes a first cooling line for cooling the trap plates by transferring the coolant to the trap plates; and a second cooling line surrounding an outer wall of the housing in order to cool the outer wall and an inner portion of the housing by circulating the coolant through the second cooling line.

The second cooling line extends to the upper plate of the housing having the first connection port.

A pitch of the second cooling line surrounding the outer wall of the housing is gradually narrowed from a lower portion to an upper portion of the housing.

The trap plates include first trap plates formed at center portions thereof with holes and second trap plates having flat plate shapes without holes, which are alternately aligned.

In addition, the first cooling line includes a first extension part for distributing the coolant, which is introduced into the housing through center portions of the trap plates, into the first and second trap plates; a second extension part branched from the first extension part and installed on the trap plate; and a third extension part connected to an end portion of the second extension part so as to discharge the coolant passing through the second extension part out of the housing.

At this time, front end portions of the first and second cooling lines are connected to one coolant-feeding pipe and terminal end portions of the first and second cooling lines are connected to one coolant discharge pipe.

The apparatus further comprises a housing bracket having a hollow cylindrical structure and being installed between a lower end portion of the body of the housing and the lower plate in order to support the first and second trap plates, wherein the first and third extension parts of the first cooling line extend by passing through a sidewall of the housing bracket, so that the first cooling line is supported by the housing bracket.

In addition, the apparatus further comprises a plurality of trap plates installed in the housing for trapping the reaction by-products heated by means of the heating unit such that the reaction by-products are deposited on the trap plates.

At this time, the cooling unit may include a first cooling line for cooling the trap plates by transferring the coolant to the trap plates; and a second cooling line surrounding an outer wall of the housing in order to cool the outer wall and an inner portion of the housing by circulating the coolant through the second cooling line.

In this case, the second cooling line extends to the upper plate of the housing having the first connection port.

In addition, the trap plates include first trap plates formed at center portions thereof with holes and second trap plates having flat plate shapes without holes, which are alternately aligned.

Furthermore, the first cooling line includes a first extension part for distributing the coolant, which is introduced into the housing through center portions of the trap plates, into the first and second trap plates; a second extension part branched from the first extension part and installed on the trap plate; and a third extension part connected to an end portion of the second extension part so as to discharge the coolant passing through the second extension part out of the housing.

### BRIEF DESCRIPTION OF THE DRAWINGS

FIG. 1 is a schematic sectional view illustrating a conventional powder trap device of semiconductor equipment;

FIG. 2 is a schematic sectional view illustrating a relationship between an apparatus for quickly catching by-products and a process chamber of semiconductor equipment according to one embodiment of the present invention;

FIG. 3 is a perspective view illustrating an external appearance of an apparatus for quickly catching by-products of semiconductor equipment according to one embodiment of the present invention;

FIG. 4 is an exploded perspective view of an apparatus for quickly catching by-products of semiconductor equipment according to one embodiment of the present invention;

FIG. 5 is a perspective view illustrating a heating unit according to one embodiment of the present invention;

FIG. 6 is a front view illustrating a heating unit modified according to another embodiment of the present invention;

FIG. 7 is a plan view illustrating a heating plate modified according to another embodiment of the present invention;

FIG. 8 is a perspective view illustrating a trap plate and a first cooling line according to one embodiment of the present invention;

FIGS. 9 to 11 are plan views illustrating trap plates according to one embodiment of the present invention;

FIG. 12 is a partially sectional front view of an apparatus for quickly catching by-products of semiconductor equipment according to one embodiment of the present invention;

FIG. 13 is a perspective view illustrating a second cooling line according to one embodiment of the present invention;

FIG. 14 is a front view of FIG. 13; and

FIG. 15 is a plan view illustrating a second cooling line according to another embodiment of the present invention, in which the second cooling line extends to an upper plate.

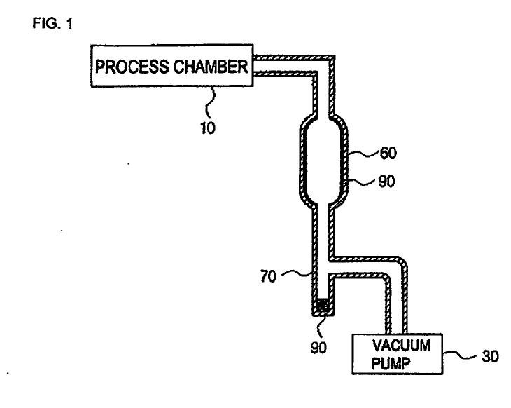

### DETAILED DESCRIPTION OF EMBODIMENTS

Hereinafter, first embodiments of the invention will be described with reference to accompanying drawings.

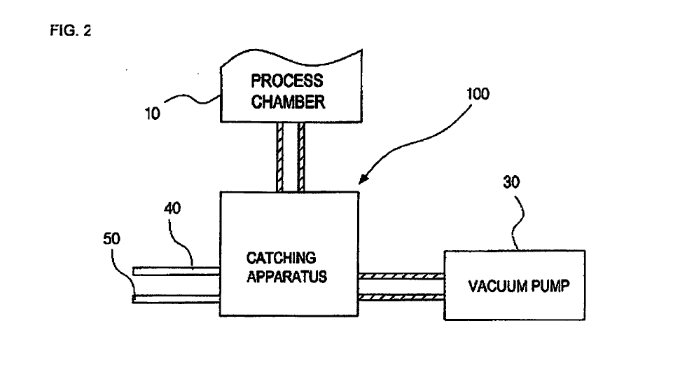

FIG. 2 is a schematic sectional view illustrating a relationship between an apparatus for quickly catching by-products of semiconductor equipment and a process chamber according to one embodiment of the present invention.

As shown in FIG. 2, the apparatus 100 for quickly catching by-products of semiconductor equipment according to one embodiment of the present invention (hereinafter, referred to as a catching apparatus) is connected to the process chamber 10, in which reaction by-products are generated when the thin film is deposited or etched. A vacuum pump 30 is connected to one side of the catching apparatus 100 in order to provide a vacuum into the process chamber 10 through the catching apparatus 100.

In addition, a coolant-feeding pipe 40 connected to an external coolant tank is coupled to a lower portion of the catching apparatus 100 so as to feed a coolant required for cooling the reaction by-products into the catching apparatus 100. A coolant discharge pipe 50 is connected to the catching apparatus 100 in order to return the coolant used in the catching apparatus 100 to the coolant tank.

Thus, the coolant is circulated through the catching apparatus 100 and the coolant tank, so that the fresh coolant is always fed into the catching apparatus 100. The coolant for promoting the catching efficiency for the reaction by-products may include cooling water or Freon gas capable of suddenly lowering the internal temperature of the catching apparatus 100.

The catching apparatus 100 having the above structure according to the present invention applies energy to the reaction by-products by heating the reaction by-products with a predetermined temperature sufficient for ionizing and chemically changing the reaction by-products generated in the process chamber 10. Thus, the reaction by-products are converted into vapor-phase reaction by-products through the chemical change. The vapor-phase reaction by-products are rapidly cooled by means of a low-temperature coolant, so that the vapor-phase reaction by-products can be deposited in the form of a lamination layer.

According to embodiments of the invention, the reaction by-products are rapidly cooled and solidified, thereby improving the catching efficiency for the reaction by-products. In addition, according to the embodiments, the reaction by-products mainly consisting of non-reacted gases are ionized and chemically changed, so that the reaction by-products are deposited at a high speed while forming a lamination layer, thereby maximizing the catching efficiency for the reaction by-products.

For reference, the catching apparatus 100 according to the present invention can be installed not only in a fore line of the vacuum pump 30, but also in an exhaust line of the vacuum pump 30. In addition, the catching apparatus 100 according to the present invention is applicable for various processes for the semiconductor device or LED. The processes and process gases adaptable for the catching apparatus 100 according to the present invention are shown in Table 1.

TABLE 1

| Processes | Process gases |
|---|---|
| Metal-Etch | Cl₂, BCl₃ |
| W-CVD | WF₆, Ar, N₂ |
| Tin/CVD | TiCl₄, NH₃ |
| BPSG | TOES, O₂, PH₃, TMB, TMP, O₃, B₂H₆ |
| Al, Al₂O₃/CVD | MPA, TMA |
| SIN/Deposition | SiH₄, NH₃ |
| PSG | SiH₄, O₂, PH TEOS |
| Silicon Oxide | SiH₄, O₂, N₂O, H₂o, CO₂ |
| Silicon Nitride | SiH₄ |

Hereinafter, description will be made in detail with regard to the structure of the catching apparatus according to the present invention.

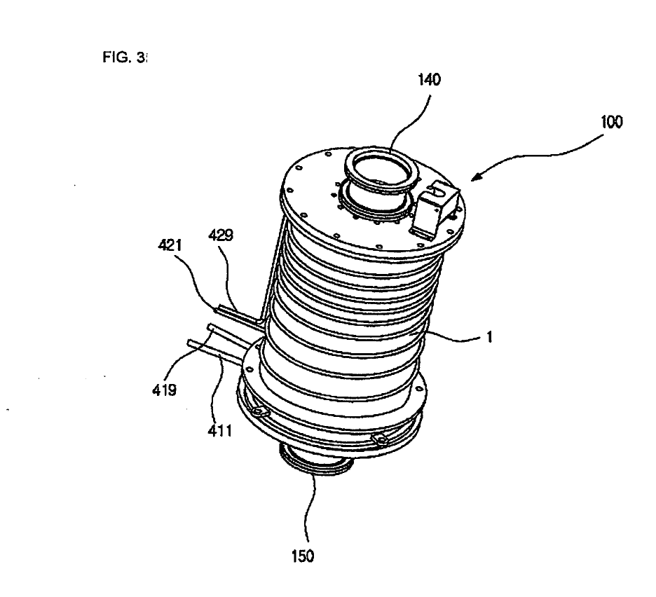

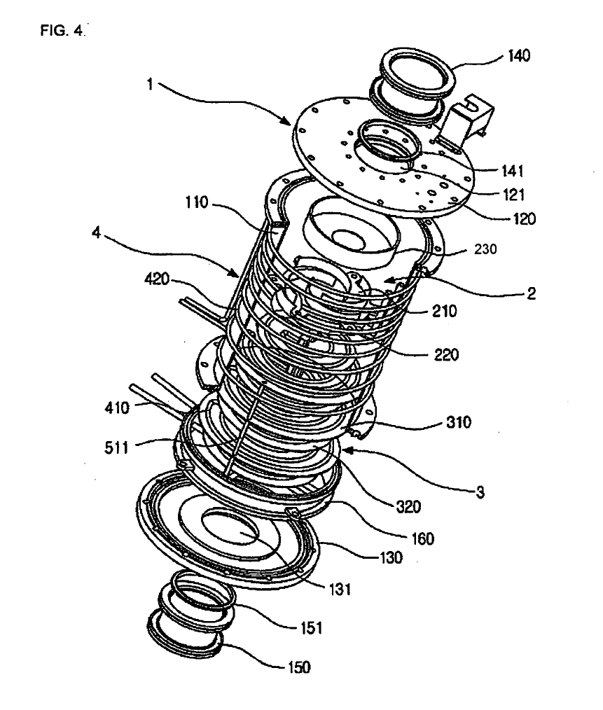

FIG. 3 is a perspective view illustrating an external appearance of the catching apparatus according to one embodiment of the present invention and FIG. 4 is an exploded perspective view of the catching apparatus according to one embodiment of the present invention.

As shown in FIGS. 3 and 4, the catching apparatus of semiconductor equipment according to the present invention includes a housing 1, a heating unit 2, a trap plate 3 and a cooling unit 4.

In the catching apparatus having the above structure, the housing 1 receives the reaction by-products from the process chamber.

The heating unit 2 applies energy to the reaction by-products while heating the reaction by-products introduced into the housing 1, thereby chemically changing the reaction by-products.

The cooling unit 4 cools the trap plate 3 and the housing 1 while circulating the coolant through first and second cooling lines 410 and 420. Thus, the cooling unit 4 allows the vapor-phase reaction by-products, which make contact with inner walls of the trap plate 3 and the housing 1, to be rapidly deposited in the form of lamination layers.

Hereinafter, description will be made in detail with regard to each element of the present invention.

First, as shown in FIGS. 3 and 4, the housing 1 includes a body 110 having a hollow cylindrical structure, and disc-shaped upper and lower plates 120 and 130, which are coupled to upper and lower portions of the body 110 by means of bolts, such that the upper and lower plates 120 and 130 can be easily assembled to or disassembled from the body 110.

Since elements of the housing 1 can be easily assembled to or disassembled from each other, repair and maintenance works for the housing 1 can be conveniently performed. Accordingly, when powder has been excessively deposited on the inner wall of the housing 1 and the trap plate 3, a user can easily remove the powder. The upper and lower plates 120 and 130 have perforation holes 121 and 131 and first and second connection ports 140 and 150 communicated with the perforation holes 121 and 131, respectively.

The first and second connection ports 140 and 150 can be coupled with the upper and lower plates 120 and 130 as individual parts as shown in FIG. 4 or can be integrally formed with the upper and lower plates 120 and 130. If the first and second connection ports 140 and 150 are coupled with the upper and lower plates 120 and 130 as individual parts, O-rings 141 and 151 are provided around the first and second connection ports 140 and 150 in order to prevent leakage of the reaction by-products.

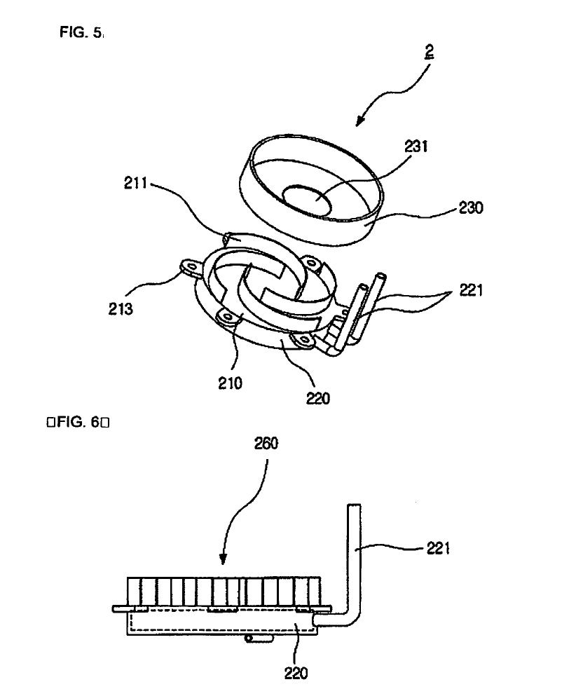

FIG. 5 is a perspective view illustrating the heating unit according to one embodiment of the present invention.

As shown in FIG. 5, the heating unit 2 according to the present invention includes a heating plate 210, a heater 220 and a cylindrical guide 230 in order to heat the reaction by-products introduced thereto from the housing 1.

The heating plate 210 is installed in the vicinity of the first connection port 140 together with the heater 200 so as to make contact with the reaction by-products introduced thereto from the housing 1. In addition, a plurality of partition walls 211 having predetermined curvatures are radially installed on an upper surface of the heating plate 210 in such a manner that the reaction by-products introduced into the center portion of the heating plate 210 can be spirally dispersed in the outer peripheral direction of the heating plate 210. That is, the reaction by-products are dispersed toward the inner wall of the housing 1. Due to the partition walls 211 radially installed on the upper surface of the heating plate 210, the reaction by-products introduced into the heating plate 210 through the first connection port 140 can be uniformly dispersed toward the inner wall of the housing 1. In addition, a long track is formed between the partition walls 211 due to the curved structure of the partition walls 211, so that the reaction by-products introduced into the center portion of the heating plate 210 are dispersed from the heating plate 210 while moving along the long track. Thus, the reaction by-products are sufficiently heated by means of the heating plate 210, so the reaction by-products may receive sufficient energy required for the chemical change thereof. In addition, the heating plate 210 is provided at an outer peripheral portion thereof with support flanges 213 for fixing the heating plate 210 to the housing by using fixing elements (not shown).

The heater 220 is provided below the heating plate 210 while making surface-contact with a lower surface of the heating plate 210. The heater 220 generates heat and supplies the heat to the heating plate 210 in order to heat the reaction by-products. Preferably, the heater 220 includes a body made of ceramic. In this case, the body of the heater 220, which surrounds heating wires connected to an external power source for generating the heat, can endure against the high-temperature while being prevented from being eroded due to the reaction by-products. In addition, protective cables 221 are provided to allow the heating wires to be introduced into the heater or drawn from the heater through the housing.

An upper portion of the cylindrical guide 230 is completely opened and the perforation hole 231 is formed at a lower center portion of the cylindrical guide 230. The cylindrical guide 230 is installed between the partition wall 211 of the heating plate 210 and the first connection port 140. In addition, the opened upper portion of the cylindrical guide 230 is communicated with the first connection port 140 and the perforation hole 231 of the cylindrical guide 230 faces an upper center portion of the heating plate 210. Owing to the cylindrical guide 230 having the above structure, the reaction by-products introduced into the cylindrical guide 230 through the first connection port 140 are guided into the upper center portion of the heating plate 210.

Meanwhile, according to another embodiment of the present invention, the heating plate 210 can be slightly modified in order to allow the reaction by-products to easily flow under the vacuum pressure.

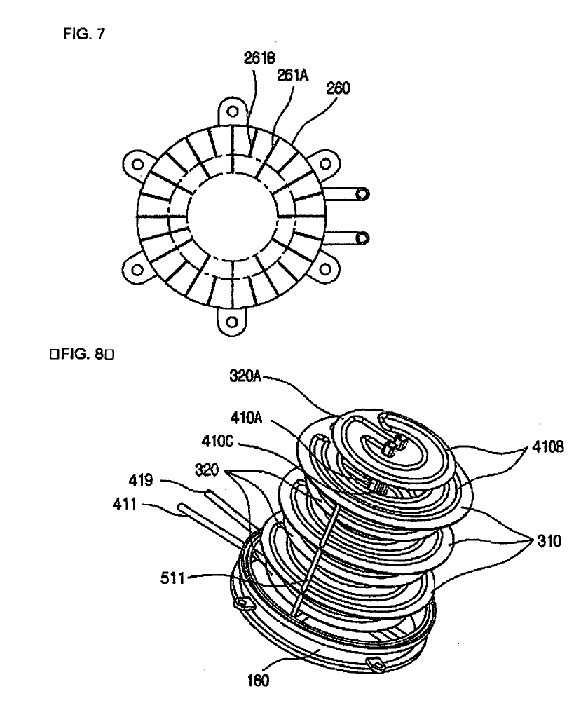

FIG. 6 is a front view illustrating a heating device modified according to another embodiment of the present invention, and FIG. 7 is a plan view illustrating the heating plate modified according to another embodiment of the present invention.

As shown in FIGS. 6 and 7, the heating plate 260 modified according to another embodiment of the present invention includes a plurality of partition walls 261A having linear plate structures. Thus, the reaction by-products introduced into the center portion of the heating plate 260 are linearly moved toward the outer peripheral portion of the heating plate 260 without forming a curved route.

If the partition walls 261A have the linear plate structures, rather than the curved plate structures, the reaction by-products can easily flow along the partition walls 261A without making contact with the curved surface of the partition walls. This is advantageous because the movement of the reaction by-products may be interrupted even if only a little resistance is applied thereto under the vacuum pressure. An interval between the partition walls 261A must be properly selected in such a manner that the partition walls 261A may sufficiently make contact with the reaction by-products while allowing the reaction by-products to easily flow along the partition walls 261A without being interrupted by the partition walls 261A.

Since the interval between the partition walls 261A is enlarged at the outer peripheral portion of the heating plate 260, auxiliary partition walls 261B having lengths shorter than those of the partition walls 261A and extending from the outer peripheral portion of the heating plate 260 toward the center portion of the heating plate 260 are provided between the partition walls 261A.

Thus, the heating plate 260 modified according to another embodiment of the present invention can enlarge the heat-exchange area with respect to the reaction by-products without interrupting the movement of the reaction by-products.

The heating plates 210 and 260 can be selectively used by taking various factors, such as installation environment of the catching apparatus, the internal pressure of the housing 1, and types of processes, into consideration.

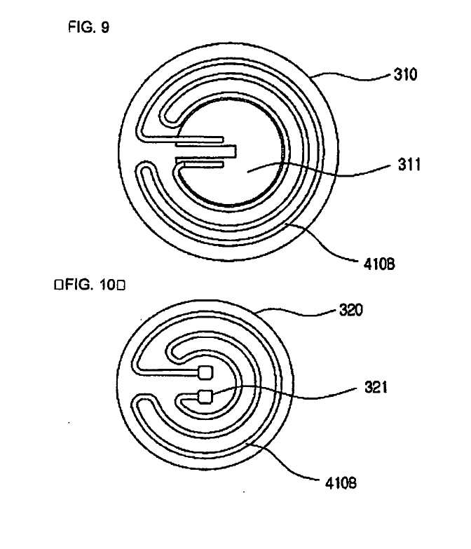

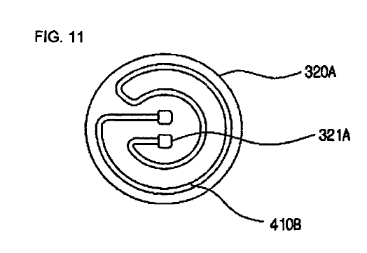

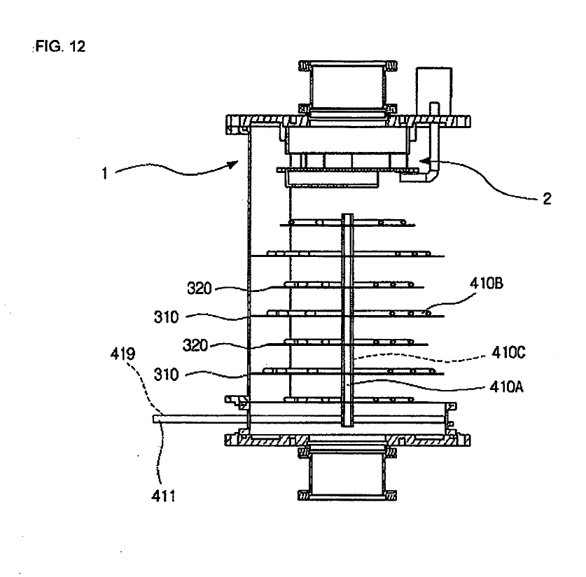

FIG. 8 is a perspective view illustrating a trap plate and a first cooling line according to one embodiment of the present invention, FIGS. 9 to 11 are plan views illustrating trap plates according to one embodiment of the present invention, and FIG. 12 is a partially sectional front view of the catching apparatus according to one embodiment of the present invention.

As shown in FIGS. 8 to 12, according to the present invention, the trap plate 3, on which the reaction by-products are deposited, is closely arranged in relation to the first cooling line 410 of the cooling unit 4 used for cooling the trap plate 3 in order to improve the catching efficiency of the trap plate 3 for the reaction by-products.

The trap plate 3 includes first trap plates 310 formed at center portions thereof with holes 311 and second trap plates 320 having substantially flat plate shapes without the holes 311. The first and second trap plates 310 and 320 are alternately aligned. An interval between adjacent first and second trap plates 310 and 320 becomes gradually reduced from the upper portion of the trap plate 3 to the lower portion of the trap plate 3. Preferably, the uppermost and lowermost layers of the trap plate 3 are formed by means of the second trap plates 320 having no holes 311 at centers thereof. The first trap plate 310 has a diameter different from that of the second trap plate 320. Preferably, the diameter of the first trap plate 310 is larger than that of the second trap plate 320. If the first trap plates 310 formed at center portions thereof with holes 311 and second trap plates 320 having diameters smaller than those of the first trap plates 310 are alternately aligned, powder can be uniformly deposited on the upper surface of each trap plate 3. The shape of the first and second trap plates 310 and 320 corresponds to the internal structure of the housing 1. That is, if the housing 1 has a hollow cylindrical structure, the first and second trap plates 310 and 320 have the disc-shaped plate structure corresponding to the hollow cylindrical structure of the housing 1. According to embodiments of the present invention, it is assumed that the first and second trap plates 310 and 320 have the disc-shaped plate structure. Among from the second plates 320, the uppermost plate 320A has a relatively small diameter, in such a manner that movement of the reaction by-products introduced into the housing 1 cannot be interrupted by the uppermost plate 320A. For reference, reference numerals 321 and 321A are holes formed in the second trap plates 320 and 320A for allowing the first cooling line 410 to pass therethrough.

As shown in FIG. 4, the first cooling line 410 forms the cooling unit 4 together with the second cooling line 420 surrounding the outer wall of the housing 1.

The first cooling line 410 includes a first extension part 410A for distributing the coolant introduced into the housing 1 over the trap plate 3 and having a front end portion 411 connected to the coolant-feeding pipe 40 so as to receive the coolant from the coolant-feeding pipe 40, a plurality of second extension parts 420B branched from the first extension part 410A and installed on the trap plate 3, and a third extension part 410C extending from the second extension parts 410B and having a terminal end portion 419 connected to the coolant discharge pipe 50 in parallel to the front end portion 411 of the first extension part 410A connected to the coolant-feeding pipe 40. The first and third extension parts 410A and 410C are introduced into the housing 1 from the exterior of the housing 1 while passing through the center portions of the first and second trap plates 310 and 320, which are alternately aligned. The second extension parts 410B are branched from the first extension part 410A and installed on upper surfaces of the first and second trap plates 310 and 320.

According to the above-described structure, the coolant fed from the coolant-feeding pipe 40 flows along the second extension parts 410B through the first extension part 410A by way of the first and second trap plates 310 and 320. Then, the coolant is collected in the third extension part 410C and is discharged to the exterior through the coolant discharge pipe 50. As the coolant is introduced into the second extension parts 410B through the first extension part 410A, the first and second extension parts 410A and 410B are cooled. In addition, upper surfaces of the first and second trap plates 310 and 320, on which the second extension parts 410B are installed, are also cooled by means of the coolant. Furthermore, the coolant may suddenly drop the internal temperature of the housing 1, in which the first and second trap plates 310 are installed.

Typically, the internal temperature of the process chamber is maintained in a range of about 400 to 500° C. when the process is being performed. However, if the coolant flows through the first and second extension parts 410A and 410B, the internal temperature of the housing 1 connected to the process chamber and the surface temperature of the trap plate 3 are significantly lowered as compared with the temperature of the process chamber. Accordingly, the reaction by-products generated in the process chamber (especially, non-reacted gases) are introduced into the housing 1 and heated by means of the heating unit 2 such that the reaction by-products are ionized. Thus, the reaction by-products are converted into the vapor-phase reaction by-products through the chemical change and the vapor-phase reaction by-products may stick to the surface of the trap plate 3, which has been cooled to have a lower temperature. At this time, the vapor-phase reaction by-products are deposited on the trap plate 3 at a high speed while forming a lamination layer.

Meanwhile, other reaction by-products, which are not deposited on the trap plate 3, are solidified while being suddenly cooled under the low-temperature atmosphere of the housing 1, so that they are directly stacked on the trap plate 3 in the form of powder. Herein, the vapor-phase reaction by-products are converted into the solid-phase reaction by-products, so the reaction by-products deposited on the surface of the trap plate 3 may be transformed into the lamination layer, so that the reaction by-products can be securely and uniformly deposited on the surface of the trap plate 3 at a high speed.

Preferably, the first and second trap plates 310 and 320 and the first cooling line 410 are made from materials having superior heat conductivity such that the internal temperature of the housing 1 can be rapidly dropped by means of the coolant.

The second extension parts 410B are installed on the first and second trap plates 310 and 320 in such a manner that a contact area between the second extension parts 410B and the first and second trap plates 310 and 320 can be maximized. That is, as shown in the figures, the second extension parts 410B are aligned on the first and second trap plates 310 and 320 while forming a circular pattern. It is also possible to align the second extension parts 410B in a zigzag pattern. In this case, the contact area between the trap plate 3 and the second extension parts 410B can be enlarged, so the internal temperature of the housing 1 and the surface temperature of the trap plate 3 can be rapidly cooled.

Meanwhile, the present invention provides a support bar 511 extending by passing through an outer peripheral portion of the first trap plate 310 in order to support the first trap plate 310. Therefore, since the first and second extension parts 410A and 410C extends by passing through the center portions of the first and second trap plates 310 and 320, the first trap plate 310 is fixedly supported by means of the support bar 511 and the second plate 320 is fixedly supported by means of the first and second extension parts 410A and 410C. For reference, the first trap plate 310 can be fixed to the support bar 511 by means of welding or storing adhesives. In the same way, the second plate 320 can be fixed to the first and second extension parts 410A and 410C by means of welding or storing adhesives.

The present invention also provides a housing bracket 160 for integrally supporting the first and second trap plates 310 and 320 and the first cooling line 410 such that they are easily assembled to or disassembled from the housing 1. The housing bracket 160 are installed between a lower end portion of the body 110 of the housing 1 and the lower plate 130. The support bar 511 is fixed to a predetermined outer peripheral portion of the housing bracket 160 so as to support the first and second trap plates 310 and 320. The front end portion 411 and the terminal end portion 419 of the first cooling line 410 extend by passing through the sidewall of the housing bracket 160, so that the first cooling line 410 is totally supported by the housing bracket 160.

Hereinafter, description will be made in relation to the second cooling line 420, which forms the cooling unit 4 together with the first cooling line 410.

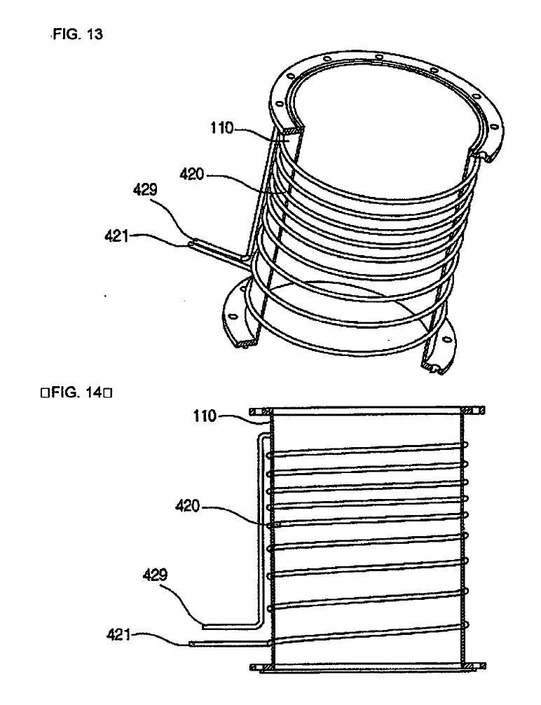

FIG. 13 is a perspective view illustrating the second cooling line according to one embodiment of the present invention and FIG. 14 is a front view of FIG. 13.

As shown in FIGS. 13 and 14, the second cooling line 420 of the cooling unit 4 according to the present invention spirally surrounds the outer wall of the body 110 of the housing 1, in which a front end portion 421 of the second cooling line 420 is positioned at a lower portion of the body 110 of the housing 1 so as to be connected to the coolant-feeding pipe 40 and an end part of the second cooling line 420 extends downward from the upper portion of the body 11 of the housing 1 such that a terminal end portion 429 of the second cooling line 420 can be connected to the coolant discharge pipe 50 at the lower portion of the body 11 of the housing 1.

If the second cooling line 420 surrounding the outer wall of the body 110 of the housing 1 is provided, the temperature of the inner wall of the housing 1 is lowered due to the coolant flowing through the second cooling line 420. Accordingly, the vapor-phase reaction by-products, which are obtained by heating the reaction by-products introduced into the housing 1 using the heating unit 2 such that they are ionized, may stick to the inner wall of the housing 1. At this time, the vapor-phase reaction by-products are deposited on the inner wall of the housing 1 at a high speed while forming lamination layers. That is, the reaction by-products are caught in the housing 1 in the form of the lamination layers.

In this way, if the cooling unit 4 includes the first and second cooling lines 410 and 420, the reaction by-products heated by means of the heating unit 2 can be uniformly deposited in the form of lamination layers at the high speed. In contrast, other reaction by-products, which are not deposited on the housing 1, are solidified while being suddenly cooled under the low-temperature atmosphere of the housing 1, so that they are directly stacked on the trap plate 3 in the form of powder.

Meanwhile, a pitch of the spiral pattern of the second cooling line 420 surrounding the outer wall of the housing 1 is gradually narrowed from the lower portion to the upper portion of the housing 1. Thus, a greater amount of coolants is heat-exchanged at the upper portion of the housing 2, in which the heating unit 2 is installed, so that the reaction by-products heated by the heating unit 2 can be easily caught at the upper portion of the housing 1.

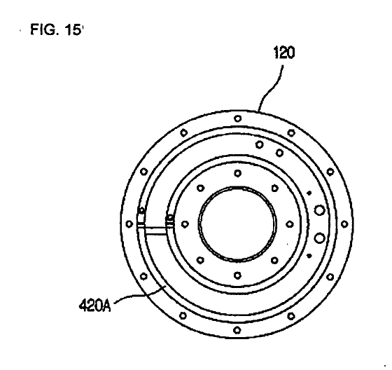

FIG. 15 is a plan view illustrating a second cooling line according to another embodiment of the present invention, in which the second cooling line extends to the upper plate.

As shown in FIG. 15, the second cooling line 420A of the cooling unit 4 according to another embodiment of the present invention not only surrounds the outer wall of the body 110 of the housing 1, but also provides a circulation path extending to the upper plate 120 of the housing 1.

If the second cooling line 420A extends to the upper plate 120 of the housing 1, a heat-exchange area between the second cooling line 420A and the housing 1 can be enlarged, so that the temperature of the housing 1 as well as the internal temperature of the housing 1 can be rapidly lowered. Thus, the reaction by-products introduced into the housing 1 can be rapidly solidified.

Hereinafter, the operation of the catching apparatus of semiconductor equipment having the above structure according to the present invention will be described with reference to accompanying drawings while focusing on the movement of the reaction by-products.

First, as the catching apparatus according to the present invention operates, the coolant is fed into the first and second cooling lines 410 and 420 of the cooling unit 4 communicated with the coolant-feeding pipe 40 connected to the external coolant tank (not shown).

Thus, the coolant having the low temperature is introduced into the housing 1 and then flows through the first cooling line 410, which is connected to both the first and second trap plates 310 and 320, so that the surface temperature of the first and second trap plates 310 and 320 and the internal temperature of the housing 1 may be significantly dropped.

In addition, the coolant having the low temperature also flows through the second cooling line 420 surrounding the outer wall of the housing 1, so that the inner wall of the housing 1 is rapidly cooled. Thus, the internal temperature of the housing 1 is further dropped.

At this time, the heater 220 of the heating unit 2 is operated together with the cooling unit 4 while generating high-temperature heat, so that the heating plate 210 making contact with the heater 220 of the heating unit 2 is heated.

Meanwhile, while the catching apparatus according to the present invention is being operated, the thin film deposition process or etching process is performed in the process chamber connected to the catching apparatus of the present invention. Thus, a great amount of reaction by-products including non-reacted gases is generated in the process chamber during the thin film deposition process or etching process. The reaction by-products are introduced into the housing 1 through the first connection port 140 as the vacuum pump operates. After that, the reaction by-products introduced into the housing 1 through the first connection port 140 are moved into the upper center portion of the heating plate 210 while being guided by the cylindrical guide 230 communicated with the first connection port 140.

The reaction by-products moved into the upper center portion of the heating plate 210 are dispersed in the outer peripheral direction of the heating plate 210. That is, the reaction by-products are dispersed toward the inner wall of the housing 1 through the track defined between the partition walls 211, which are radially installed on the upper surface of the heating plate 210. At this time, the reaction by-products making contact with the heating plate 210 may receive heat from the heating plate 210, so that energy required for ionizing the reaction by-products is fed into the reaction by-products. Thus, non-reacted gases generated in the process chamber may be subject to the chemical change, so that the non-reacted gases are converted into vapor-phase solid materials and gaseous materials. Then, the reaction by-products being dispersed in the outer peripheral direction of the heating plate 210 make contact with the inner wall of the housing 1 and the surface of the trap plate 3 having the low temperature. As the vapor-phase reaction by-products make contact with the housing 1 and the trap plate 3, the vapor-phase reaction by-products are rapidly cooled so that the vapor-phase reaction by-products are being rapidly solidified and deposited on the inner wall of the housing 1 and the surface of the trap plate 3. At this time, the vapor-phase reaction by-products are deposited on the inner wall of the housing 1 and the surface of the trap plate 3 in a state in which the vapor-phase reaction by-products are not completely solidified, so that the vapor-phase reaction by-products can be rapidly deposited in the form of the lamination layer 9

Meanwhile, other reaction by-products, which have not been deposited on the inner wall of the housing 1 and the surface of the trap plate 3, are solidified as they flow downward along the housing 1 due to the low temperature of the housing 1. That is, a part of the reaction by-products is stacked on the surface of the uppermost plate of the second trap plates 320 having the flat plate shape, and the remaining of the reaction by-products flows downward along the peripheral portions of the second trap plates 320 so that reaction by-products are stacked on the surface of the first trap plate 310 formed at the center portion thereof with the hole. Thus, the reaction by-products are dropped onto the second trap plate 320 positioned below the first trap plate 310 through the hole formed at the center portion of the first trap plate 310. In this way, the reaction by-products flowing along the peripheral portion of the second trap plate 320 are dropped onto the upper surface of the first trap plate 310 positioned below the second trap plate 320 so that a part of the reaction by-products dropped onto the upper surface of the first trap plate 310 is stacked on the upper surface of the first trap plate 310, and remaining of the reaction by-products is again dropped onto the surface of the second trap plate 320 positioned below the first trap plate 310 through the hole formed at the center portion of the first trap plate 310. As a result, the reaction by-products in the form of powder are uniformly staked on the first and second trap plates 310 and 320. That is, the powder is uniformly stacked from the uppermost layer to the lowermost layer of the second trap plates 320.

In this way, according to the present invention, most of the reaction by-products introduced into the housing 1 can be rapidly deposited on the inner wall of the housing and the inner wall of the trap plate 3 in the form of lamination layers. In addition, the remaining of the reaction by-products is solidified in the form of powder due to the lower temperature of the housing 1 and is uniformly staked on the trap plate 3, so that the reaction by-products can be rapidly and uniformly staked in the housing 1.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

As can be seen from the foregoing, the catching apparatus of semiconductor equipment according to the present invention has advantages as follows:

First, the reaction by-products generated in the process chamber are heated such that they are ionized and the vapor-phase reaction by-products obtained through the chemical change are rapidly cooled and deposited in the form of lamination layers, so that the reaction by-products can be rapidly stacked in the housing.

Second, while the reaction by-products are being deposited in the form of lamination layers, other reaction by-products, which has not been deposited, are also rapidly solidified in the form of powder under the lower temperature atmosphere of the housing and the powder is uniformly stacked on the trap plate, so that the efficiency of catching the reaction by-products can be improved.

Third, the reaction by-products can be securely deposited on the housing and the trap plate, thereby preventing powder from penetrating into the vacuum pump. Thus, malfunction of the vacuum pump can be prevented. In addition, the powder is prevented from flowing back toward the process chamber, so it is possible to prevent the wafer from being contaminated.

Fourth, since the powder is uniformly stacked on the inner walls of the housing and the trap plate, it is possible to trap the powder for a long period of time, so that it is not necessary to frequently remove the powder, thereby improving workability of semiconductor equipment.

What is claimed is:

1. A method of collecting at least one chemical compound from semiconductor processing, the method comprising:
flowing gas comprising at least one chemical compound in a flow direction;
heating at least part of the gas while the gas flows generally in the flow direction;
cooling at least part of the heated gas while the gas flows generally in the flow direction; and
depositing at least part of the chemical compounds on at least one deposition surface provided along the flow direction.

2. The method of claim 1, wherein heating comprises contacting the at least part of the gas with a heating surface.

3. The method of claim 2, wherein the heating surface is heated to a temperature from about 150° C. to about 550° C.

4. The method of claim 2, wherein at least some gaseous particles momentarily move in a direction substantially opposite the flow direction after contacting the heating surface.

5. The method of claim 1, wherein the at least one chemical compound ionizes upon heating.

6. The method of claim 1, wherein cooling comprises contacting the at least part of the heated gas with a cooling surface.

7. The method of claim 1, wherein the cooling surface is cooled to a temperature from about −40° C. to about 25° C.

8. The method of claim 1, wherein depositing comprises cooling at least part of the gas that contacts the deposition surface.

9. The method of claim 1, wherein heating, cooling and depositing are conducted in a single chamber.

10. The method of claim 1, wherein the chamber comprises an interior surface, which is cooled, and wherein cooling comprises contacting the at least part of the heated gas with the interior surface.

11. The method of claim 1, wherein heating, cooling and deposition are conducted in two or more consecutively arranged chambers.

12. The method of claim 1, wherein the gas comprises at least one selected from the group consisting of Cl₂, BCl₃, WF₆, Ar, N₂, TiCl₄, TOES, PH₃, TMB, TMP, O₂, O₃, B₂H₆, MPA, TMA, Al, Al₂O₃, SiH₄, NH₃, PH TEOS, N₂O, H₂O, CO₂ and a compound obtained from a reaction between at least two of the foregoing compounds.

13. The method of claim 1, wherein the at least one deposition surface is generally perpendicular to the flow direction.

14. A method of collecting at least one chemical compound from semiconductor processing, the method comprising:
flowing gas comprising at least one chemical compound in a flow direction;
ionizing the at least one chemical compound while the gas flows generally in the flow direction;
cooling at least part of the gas while the gas flows generally in the flow direction; and
depositing at least part of the chemical compounds on at least one deposition surface provided along the flow direction.

15. The method of claim 14, wherein ionizing comprises heating the at least one chemical compound.

16. The method of claim 14, wherein ionizing comprises applying radio frequency radiation to the gas flowing in the flow direction.

17. An apparatus for collecting at least one chemical compound from semiconductor processing, the apparatus comprising:
an inlet configured to receive a gaseous flow comprising at least one chemical compound;
a heater configured to heat at least part of the gaseous flow;
a cooler configured to cool the at least part of the heated gaseous flow; and
at least one deposition plate configured to deposit at least one chemical compound thereon.

18. The apparatus of claim 17, wherein the heater comprises a heating surface substantially perpendicular to the direction of the gaseous flow.

19. The apparatus of claim 17, wherein the heater comprises at least one guide plate configured to direct the gaseous flow to the cooler.

20. The apparatus of claim 18, wherein the heating surface is configured to heat to a temperature from about 150° C. to about 550° C.

21. The apparatus of claim 18, wherein the heating surface is configured to heat to a temperature sufficient to ionize the at least one chemical compound.

22. The apparatus of claim 17, wherein the cooler comprises at least one cooling surface which is cooled by a coolant.

23. The apparatus of claim 22, wherein the at least one deposition plate comprises a cooling surface.

24. The apparatus of claim 17, wherein the deposition plate is configured to cool to a temperature from about −40° C. to about 25° C.

25. The apparatus of claim 17, wherein the at least one deposition plate surface comprises a surface substantially perpendicular to the gaseous flow.

26. A semiconductor processing equipment comprising:
a semiconductor processing chamber configured to process an intermediate semiconductor device with at least one chemical compound therein;
a chemical compound collector configured to collect the at least one chemical compound discharged from the semiconductor processing chamber;
wherein the chemical compound collector comprises:
an inlet configured to receive a gaseous flow from the semiconductor processing chamber, the gaseous flow comprising the at least one chemical compound;
means for heating at least part of the gaseous flow;
means for cooling the at least part of the heated gaseous flow; and
means for depositing at least one chemical compound thereon.
